(19) United States
(12) Patent Application Publication
(10) Pub. No.: US 2003/0141083 A1
(43) Pub. Date: Jul. 31, 2003

(54) FIRE EXTINGUSHING SYSTEM

(76) Inventor: Julius Long JR., Charleston, SC (US)

Correspondence Address: GREENBERG & LIEBERMAN, 314 PHILADELPHIA AVE., TAKOMA PARK, MD, 20912, US

(21) Appl. No.: 10/248,609

(22) Filed: Jan. 31, 2003

Related U.S. Application Data
(60) Provisional application No. 60/352,497, filed on Jan. 31, 2002.
(60) Provisional application No. 60/354,212, filed on Feb. 7, 2002.
(60) Provisional application No. 60/354,211, filed on Feb. 7, 2002.
(60) Provisional application No. 60/354,213, filed on Feb. 7, 2002.
(60) Provisional application No. 60/361,371, filed on Mar. 5, 2002.
(60) Provisional application No. 60/361,370, filed on Mar. 5, 2002.
(60) Provisional application No. 60/352,498, filed on Jan. 31, 2002.
(60) Provisional application No. 60/361,372, filed on Mar. 5, 2002.
(60) Provisional application No. 60/372,825, filed on Apr. 17, 2002.
(60) Provisional application No. 60/372,823, filed on Apr. 17, 2002.
(60) Provisional application No. 60/372,824, filed on Apr. 17, 2002.

(51) Int. Cl. A62C 2/00

(52) U.S. Cl. 169/84

(57) ABSTRACT

A method of for stopping and containing fires involving, in one embodiement, taking the fumes from a turbine, jet or any chemical source, and running it through a giant muffler, radiator or pipe if needs cooling. The radiator cools the fumes down from the engine or chemical source. This is a system that uses the fumes to cool the fire down, and blow the oxygen away. When the gasses pass over the fire, it will suck the heat and oxygen away, and replace it with a non-combustible gas. This system can also be used to put architectural fires, by blowing the fumes in the building from one side, keeping oxygen from entering the building, by building up pressure, until no more oxygen can enter the building. This is essentially a mechanism or means that one way inject water into flow of the fumes.

### CROSS REFERENCE TO RELATED APPLICATIONS

Priority claimed to the following applications: Ser. Nos. 60/352,497; 60/354,212; 60/354,211; 60/354,213; 60/361,371; 60/361,370; 60/352,498; 60/361,372; 60/372,825; 60/372,823; 60/372,824.

### SUMMARY OF INVENTION

The present invention has to do with safety, and more specifically, preventing the spread and destroying fires.

The present invention is a system for extinguishing fires. There are several embodiments that describe how to safely, and effectively, prevent a fire from destroying buildings and injuring people.

### DETAILED DESCRIPTION

For oxygen and heat replacement, take the fumes from a jet engine, run them through a giant muffler or radiator approximately the size of a 20 foot tanker or larger. The radiator cools the fumes down from the jet engine. This system that uses the fumes to cool the fire down, and blow the oxygen away. When the gases pass over the fire, it will suck the heat and the oxygen away, and replace it with a non-combustible gas. This system can also be used to put out architectural fires, by blowing the fumes in the building from one side, keeping oxygen from entering the building, until no more oxygen can enter the building. For living quarters, use natural gas or propane fumes.

In other words, and in addition, take the fumes from a turbine, jet or any chemical source, run it through a giant muffler, radiator or pipe if needs cooling. The radiator cools the fumes down from the engine or chemical source. This is a system that uses the fumes to cool the fire down, and blow the oxygen away. When the gasses pass over the fire, it will suck the heat and oxygen away, and replace it with a non-combustible gas. This system can also be used to put architectural fires, by blowing the fumes in the building from one side, keeping oxygen from entering the building, by building up pressure, until no more oxygen can enter the building. This is essentially a mechanism or means that one way inject water into flow of the fumes.

Alternative embodiments include a nozzle or a type of fire equipment that is used to control the direction of flow and force of fumes emitted from the turbine, exhaust, or any machinery that was designed to build thrust or force behind fumes for the purpose of fire fighting.

Another embodiment involves, when a fire is burning in a building, smothering the fire with a fireproof covering, via a crane or aircraft. In some cases, there is a way of blowing fumes through an opening in the covering. Also, when the device is completely or partially covered, there is an explosive device allowing an explosion or explosions to occur in the building in order to force oxygen out, and allow a non-combustible gas to enter the building.

A further embodiment also deals with when a fire is in a building and people are in the building. In such embodiment, there is some method of forcing air in the direction of the fumes, to prevent the fumes from spreading throughout the building, at the same time, have a device such as a fan blowing out and away from the fire acting as a vacuum to pull the fire out of the open areas of the building. When people are in the building and a jet or turbine engine is being used; if possible, use propane gas, natural gas, or a fuel that is not highly toxic to humans when burned.

Further, another embodiment uses a jet or turbine engine for fighting fires. When it is suspended from something like a crane or helicopter, the force from the engine will want to go upward if the fumes are being blown with a great amount of force. To counteract this, there will be a plate with a hole suspended below the flames and attached to the jet engine in such a way that part of the fumes will force the engine down, and part will go through a hole to allow the fumes to blow the fire out. This can also be an engine with the thrust being forced in different directions to keep the engine stable.

Other embodiments involve taking a container holding non-combustible balloons attached to each other, and release them into a room, with a mat or covering that would retard oxygen from the room, while not letting heat escape. The present invention is not limited to the sole embodiments described above, but encompasses any and all of the embodiments in the following claims.

1. A fire extinguishing system, comprising:
running the fumes from a jet engine through a giant muffler or radiator;
cooling the fumes down from jet engine in the muffler or radiator;
passing the fumes over a fire;
sucking the heat and oxygen way from the fire; and
replacing the heat and oxygen with non-combustible gas.
